(19) United States
(12) Patent Application Publication
(10) Pub. No.: US 2012/0202171 A1
(43) Pub. Date: Aug. 9, 2012

(54) DENTAL APPLIANCE

(76) Inventor: Lissa T. D'Anjou, Strafford, NH (US)

(21) Appl. No.: 13/022,090

(22) Filed: Feb. 7, 2011

(51) Int. Cl. A61C 13/23; A61C 13/087

(52) U.S. Cl. 433/180; 433/172; 433/212.1

(57) ABSTRACT

This invention provides a dental appliance for concealing a missing tooth that is easy and inexpensive to fabricate and does not require the patient to spend a lot of time in the dentist's chair or make multiple visits to the dentist's office to be fitted for the appliance. The device of the present invention is made of a dental restorative material and a thermoplastic material. The thermoplastic material is clear in color, which makes it appear almost non-existent, flexible, and one solid piece. The restorative material in the dental appliance is similar to tooth structure because it is capable of expansion and contraction.

### TECHNICAL FIELD

This invention relates to a dental appliance. More specifically, the invention relates to a dental appliance for concealing a missing tooth on a temporary basis.

### BACKGROUND

Modern dentistry can accomplish seeming miracles for those patients who can afford to pay the price, but offers little for many others who would like to have better looking teeth without the time, discomfort, and expense associated with extensive dental work. Despite the wide variety of restorative dental techniques and cosmetic dental devices available to consumers, there is no known dental device that is inexpensive, easy to fit and wear, and readily adaptable to both entertainment and cosmetic purposes. Fitting typical, presently available devices requires a multistep, iterative process which can be difficult for persons with limited manual dexterity. In addition, many consumers find it difficult or uncomfortable to make an impression of their own natural teeth for fitting purposes.

In the past, when faced with a missing tooth, patients have the option to leave the extraction site alone. This leaves a gap in the smile of the patient.

Another commonly used device is called a “flipper”. A dental flipper is the least expensive way to replace a missing tooth. Often it is used as a temporary tooth replacement while a patient waits for a dental bridge or for healing after a dental implant is placed. A dental flipper is made out of acrylic. It is made by taking an impression of the patient's mouth, and then a plaster cast is poured. The cast is sent to a laboratory with a prescription that includes the shade of the tooth. An acrylic tooth is selected that most closely matches the shade of the patient's teeth, and a pink plate is molded to fit the palate (on the upper) or to fit just inside the tongue side of the teeth (on the lower).

While a dental flipper is meant to be temporary, some people wear them for years. They press somewhat on the gums and thus are not very healthy for the gums. They also break easily, and it can be difficult to eat with them because there are no clasps to hold onto surrounding teeth. Thus, they may not be strong enough to eat on and may have to be removed for meals.

Another device currently in the marketplace is Snap-On Smile™, which uses a hi-tech dental resin to make it very thin yet strong. This device fits right over the patient's teeth to give them a natural looking smile, while covering stains, chips, gaps or missing teeth. The patient may eat and drink while wearing the device and may wear it all day every day. The device must be removed when the patient is sleeping. However, this device is quite expensive and requires several visits to fabricate.

A dental partial is a prosthetic that a patient places in their mouth to replace the function and appearance of a few missing teeth when some natural teeth remain. It is usually made of metal and plastic. It is possible to get removable partial dentures or fixed partial dentures.

A fixed dental partial attaches artificial teeth to the jaw with dental implants. Usually, it takes between two to four dental implants to create a fixed dental partial. Removable dental partials consist of a metal framework with plastic teeth and gum areas. Metal clasps hold the partials in place, but they can be removed easily for cleaning.

Partial dentures make it easier for you to speak and chew. They help maintain the shape of your face and help prevent remaining teeth from shifting. Dental partials prevent problems that are caused by changes in teeth spacing, such as TMJ, headaches and earaches.

Instead of a removable or fixed bridge, many patients with a missing tooth are choosing dental implants for replacement. Implants look, feel, and function like a solid, natural teeth because they mimic tooth structure. The procedure involves placement of a small titanium screw into the jaw.

A dental implant crown must be designed to encourage up and down biting forces. An dental implant supports up and down biting forces very well but cannot deal with shaking forces. It's like a fence post, when you push down on a fence post it resists the pushing, but when you shake a fencepost it gets loose. Any biting motions that are from side to side can be harmful. When placed in the back of the mouth, the restoration must be relatively flat so that when the patient chews side to side, it doesn't catch and shake.

Thus, there is a need for a dental accessory device made of nontoxic and nonirritating materials, that can accommodate a variety of dental conditions, and that can be worn over the user's own teeth and gums to enhance his or her appearance. Such a device could be worn whenever the user wished to enhance his or her appearance. It should be simple and easy to fit, easy to refit, comfortable to wear, difficult to detect, and allow the user to speak and drink normally. The availability of a suitable dental accessory that could be worn whenever the user wished to feel more confident about his or her appearance, and to appear more attractive is a needed addition to the array of dental products.

### SUMMARY

This invention overcomes the disadvantages of the prior art by providing a dental appliance for concealing a missing tooth that is easy and inexpensive to fabricate and does not require the patient to spend a lot of time in the dentist's chair or make multiple visits to the dentist's office to be fitted for the appliance.

The device of the present invention is made of a dental restorative material and a thermoplastic material. The thermoplastic material is clear in color, which makes it appear almost non-existent, unlike partials and flippers which normally come in only a few shades. Additionally, the thermoplastic material is flexible, unlike the flipper which is hard. This makes the dental appliance of the present invention less likely to break like acrylic partials, including metal framework partials and dentures.

Further, the thermoplastic material is one solid piece, while acrylic is a monomer and a polymer (powder and liquid). Because acrylic is a mixture, it may contain bubbles or discrepancies.

Unlike partials or dentures, which may chip or break if they fall on a hard surface, the thermoplastic material of the dental appliance will not break.

The restorative material in the dental appliance is similar to tooth structure because it is capable of expansion and contraction, unlike the teeth used in most partials and dentures, which are usually made of plastic.

The restorative material of the dental appliance can be mixed to blend together to mimic different shades within a tooth. This cannot be done with plastic teeth, which only come in one shade.

The thermoplastic material as well as the restorative material of the dental appliance feel more comfortable than a partial or a denture because they are thin materials, which make the appliance less invasive to the tongue and, in turn, makes it easier for the user to speak.

The dental appliance of the present invention is easier for the user to adapt to wearing, which in turn, allows the user smile without fear of the appliance falling out because the appliance is lightweight.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is an exploded view of the dental appliance of the present invention shown separated from the mouth of a user. FIG. 1A is a perspective view of the dental appliance. FIG. 1B shows the location in the mouth of a user where the dental appliance may be seated.

FIG. 2A is a buccal view of the dental appliance of the present invention. FIG. 2B is a lingual view of the dental appliance of the present invention.

FIG. 3 is a perspective view of the dental appliance shown positioned in the mouth of a user.

### DETAILED DESCRIPTION

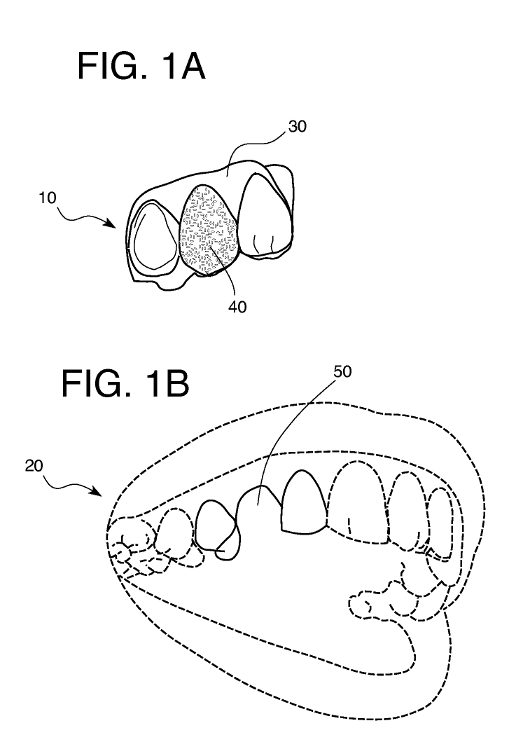

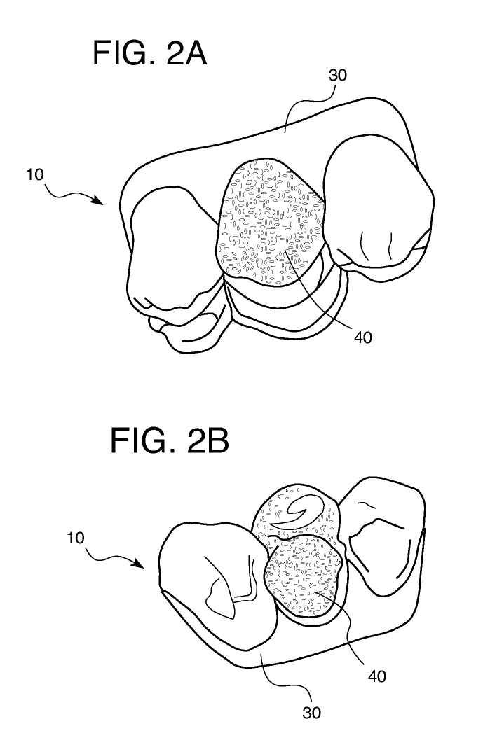

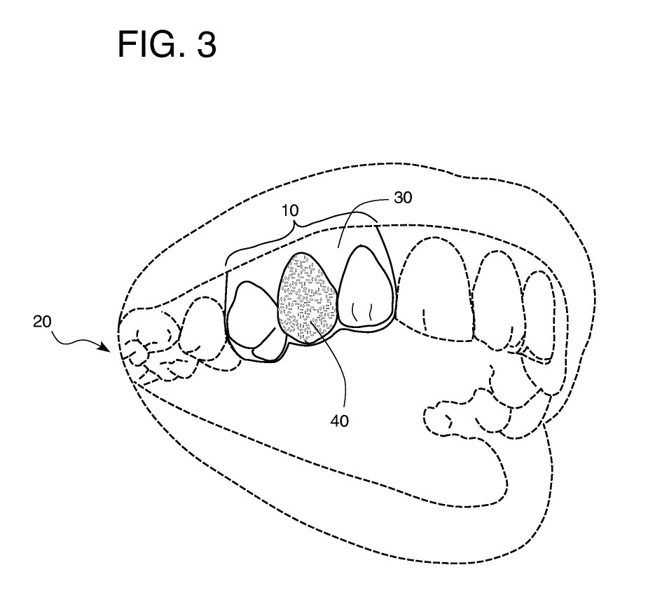

Referring to FIGS. 1 to 3, a model 20 of the user's mouth is created using a mold. Common materials used for dental impression molds are sodium alginate, polyether and silicones. Historically, plaster of Paris, zinc oxide eugenol and agar have been used.

Any existing bubbles are removed from model 20. The oral anatomy of model 20 is detailed with a scaling instrument or lab knife. If necessary, any holes in model 20 are filled in. The base of model 20 is trimmed on a model trimmer to be parallel to the occlusal surface of the tooth. A liquid separating solution is placed on model 20 with a brush. The liquid separating solution allows the thermoplastic material 30 used to create the dental appliance 10 to be easily removed. Model 20 is positioned in the center of the platform of a vacuum forming machine over lead pellets. A suitable amount of lead pellets are positioned around model 20 to prevent thermoplastic material 30 from stretching over areas of model 20 that are not part of the design of dental appliance 10. The lead pellets are used to support model 20 and make it as level as possible. Once the vacuum forming machine has been pre-heated for the proper amount of time, thermoplastic material 30 is engaged to perform the pressure molding process. Once the machine has cooled down, model 20 with molded thermoplastic material 30 is then removed from the vacuum forming machine. Model 20 is separated from molded thermoplastic material 30 by quickly tapping model 20 against a hard surface.

Thermoplastic material 30 is then trimmed with a dental lab bur and smoothed with a polishing wheel. A high speed handpiece with a #330 bur is used to make a few small holes through the facial of the missing tooth 50. A bonding agent is brushed on to the interior and the exterior of thermoplastic material 30 where missing tooth 50 is located. This area is light cured for at least 5 seconds. A dental restorative material 40, such as light cured resin base composite, is expressed into the interior of missing tooth space 50 to completely cover the buccal, lingual, and occlusal sections. An adhesive is used to help compact it down, along with a flat instrument. Before curing dental restorative material 40, dental appliance 10 should be placed on model 20 to make sure there are no undercuts. It should also be ensured that there is a small space from the gingiva of where the extraction site is.

In another embodiment of the present invention, dental appliance 10 may be used as a concealing cap for an implant.

If further concealment of dental appliance 10 is desired, adhesive should be added to the exterior of dental appliance 10 where the facial of the missing tooth 50 is located. Light cure the appliance for at least another 5 seconds and place a thin amount of the composite to the whole facial, but only to the incisal edge. This is to avoid affecting the occlusion in any way.

Ideally, dental restorative material 40 should be of a shade that matches the patient's teeth.

In one embodiment, thermoplastic material 30 used in dental appliance 10 is a copolyester. Copolyester forms when modifications are made to polyesters, which are combinations of diacids and diols. Copolyesters retain their strength, clarity and other mechanical properties despite being exposed to a variety of chemicals that typically affect other materials, such as polycarbonates.

In one embodiment, dental restorative material 40 is a composite resin. Composite resins are most commonly composed of Bis-GMA monomers or some Bis-GMA analog, a filler material such as silica and in most current applications, a photoinitiator. Dimethacrylates are also commonly added to achieve certain physical properties such as flowability. A dental composite typically consists of a resin-based oligomer matrix, such as a bisphenol Aglycidyl methacrylate (BISGMA) or urethane dimethacrylate (UDMA), and an inorganic filler such as silicon dioxide (silica).

Compositions vary widely, with proprietary mixes of resins forming the matrix, as well as engineered filler glasses and glass ceramics. The filler gives the composite wear resistance and translucency. A coupling agent such as silane is used to enhance the bond between these two components. An initiator package, such as: camphorquinone (CQ), phenylpropanedione (PPD) or lucirin (TPO), begins the polymerization reaction of the resins when external energy, such as light and/or heat is applied. A catalyst package can control the speed of the polymerization.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

1. A dental appliance for the temporary replacement of a tooth comprising:
a thermoplastic material; and
a dental restorative material.

2. The dental appliance of claim 1 wherein the thermoplastic material is a copolyester.

3. The dental appliance of claim 1 wherein the dental restorative material is a bisphenol Aglycidyl methacrylate.

4. The dental appliance of claim 1 wherein the thermoplastic material is pressure molded to a model of a mouth of a user having a missing tooth, wherein the thermoplastic material is separated from the model, and wherein the thermoplastic material is trimmed and smoothed.

5. The dental appliance of claim 4 wherein a bonding agent is applied to an interior portion and an exterior portion of the thermoplastic material where the missing tooth is located.

6. The dental appliance of claim 5 wherein the interior portion and the exterior portion of the thermoplastic material are light cured for at least 5 seconds.

7. The dental appliance of claim 1 wherein the dental restorative material is expressed into the interior portion of the thermoplastic material to completely cover a buccal section, a lingual section, and an occlusal section of the interior portion.

8. The dental appliance of claim 1 wherein an adhesive is applied to the dental restorative material and the exterior portion of the thermoplastic material.

9. The dental appliance of claim 1 wherein the dental restorative material is light cured for at least 5 seconds.

10. A method of making a dental appliance comprising:
pressure molding a thermoplastic material to a model of a mouth of a user having a missing tooth;
separating the thermoplastic material from the model;
trimming and smoothing the thermoplastic material;
applying a bonding agent to an interior portion and an exterior portion of the thermoplastic material where the missing tooth is located;
light curing the interior portion and the exterior portion of the thermoplastic material for at least 5 seconds;
expressing a dental restorative material into the interior portion of the thermoplastic material to completely cover a buccal section, a lingual section, and an occlusal section of the interior portion of the thermoplastic material;
applying an adhesive to the dental restorative material and the exterior portion of the thermoplastic material; and
light curing the dental restorative material for at least 5 seconds.
